(19) United States
(12) Patent Application Publication
(10) Pub. No.: US 2026/0073085 A1
(43) Pub. Date: Mar. 12, 2026

(54) METHODS FOR GENERATIVE DESIGN OF COLD-REGION URBAN PEDESTRIAN SPACE LAYOUT BASED ON DYNAMIC THERMAL COMFORT PREDICTION

(71) Applicant: HARBIN INSTITUTE OF TECHNOLOGY, Harbin (CN)

(72) Inventors: Cheng SUN, Harbin (CN); Yunsong HAN, Harbin (CN); Shuangyu XU, Harbin (CN); Hongji CUI, Harbin (CN); Qihui ZHANG, Harbin (CN); Zhaohan BAI, Harbin (CN)

(73) Assignee: HARBIN INSTITUTE OF TECHNOLOGY, Harbin (CN)

(21) Appl. No.: 19/325,460

(22) Filed: Sep. 10, 2025

(30) Foreign Application Priority Data
Sep. 10, 2024 (CN) 202411262892.2

(51) Int. Cl. G06F 30/13; G06F 30/12; G06F 30/18; G06F 30/27; G06F 111/04; G06F 119/08

(52) U.S. Cl. CPC G06F 30/13; G06F 30/12; G06F 30/18; G06F 30/27; G06F 2111/04; G06F 2119/08

(57) ABSTRACT

A method for generative design of a cold-region urban pedestrian space layout based on dynamic thermal comfort prediction is provided. The method includes: constructing a wayfinding agent model in a cold-region pedestrian space based on big data and IoT data to obtain pedestrian trajectories during a plurality of travel periods in the cold-region pedestrian space; constructing a mapping between thermal environment data of the cold-region pedestrian space and pedestrian thermal sensation based on physiological indicator data of pedestrians to obtain pedestrian thermal sensation under different thermal environment changes; optimizing the cold-region pedestrian space layout design based on prediction results of pedestrian thermal sensation under typical pedestrian trajectories during the plurality of travel periods; and determining a cold-region pedestrian space layout decision model guided by preferences of the designers based on machine learning models and decision feedback of designers on visual solutions.

### CROSS-REFERENCE TO RELATED APPLICATIONS

This application claims priority to the Chinese Patent Application No. 202411262892.2, filed on Sep. 10, 2024, the contents of which are hereby incorporated by reference.

### TECHNICAL FIELD

The present disclosure relates to the field of thermal comfort prediction in cold-region urban areas, and in particular, relates to a method for generative design of a cold-region urban pedestrian space layout based on dynamic thermal comfort prediction.

### BACKGROUND

With the advancement of related research, the concept of thermal comfort has continuously evolved to better describe thermal perception of users in real thermal environments. Early studies equated thermal neutrality with thermal comfort, thus defining thermal comfort at that stage as a state in which the user feels neither cold nor hot. This concept emphasized the direct stimulation of the sensory system by the thermal environment while neglecting the subjective influence of psychological factors on thermal sensation. Under this concept, thermal comfort was considered steady-state and time-invariant. However, studies by de Dear et al. indicate that thermal sensation is not only related to the immediate thermal state but also influenced by thermal history, thermal expectations, and levels of thermal adaptation. As a result, thermal sensation is in fact dynamic, continuous, and individualized, modulated by the phenomenon of thermal alliesthesia. Under these circumstances, thermal neutrality does not necessarily lead to the most positive thermal experience; their research found that brief deviations from thermal neutrality within a certain range may elicit pleasant sensations. Therefore, thermal pleasure has been incorporated into the consideration of thermal comfort. On this basis, a dynamic thermal comfort theory that accounts for continuous environmental influences has been proposed to describe users'subjective thermal perception in non-steady-state environments.

Current prediction methods for thermal comfort are still primarily based on steady-state models, and their predictions consider only the degree of deviation from thermal neutrality without accounting for thermal pleasure. Commonly used thermal comfort models include single-node, two-node, and multi-node models. The single-node thermal comfort model treats the human body as a single node representing the whole-body thermal state. This model typically evaluates thermal comfort via heat-balance relationships, including mean body temperature and sweat evaporation rate. It primarily includes Fanger's PMV and PPD models, and widely adopted thermal comfort standards such as ASHRAE 55-2016 and ISO 7730 draw upon it. Using air temperature, humidity, air velocity, radiant temperature, clothing insulation, and metabolic rate as inputs, it predicts the average vote of people's perception of the thermal environment. The model is a steady-state model that does not consider thermal history, nor does it account for changes in temperature and comfort over time during thermal equilibration. The two-node thermal comfort model divides the human body into two nodes: core and skin. Compared to the single-node model, it can more accurately simulate the body's heat transfer and thermoregulation processes, such as the heat exchange between the core and the skin. It primarily includes Gagge et al.'s SET model, which uses an equivalent temperature index for thermal comfort prediction and evaluation. Although this model accounts for heat exchange within the body, it is generally still applied under steady-state assumptions and also does not consider the influence of thermal history. The multi-node thermal comfort model further divides the human body into a plurality of nodes, such as the head, torso, and limbs, to simulate temperature and thermal perception in different parts of the body. It enables a more refined simulation of temperature distribution and thermoregulatory processes across body segments. It primarily includes the UTCI model, which employs complex physiological and thermoregulatory modeling to convert heat stress levels under different environmental conditions into an equivalent temperature index. Although this model can simulate non-steady-state environments, it still evaluates thermal comfort based on the degree of deviation from thermal neutrality and does not incorporate thermal pleasure. As a result, it inadequately addresses the influence of psychological factors on the user's thermal perception. In summary, existing thermal comfort models insufficiently account for continuous dynamic environmental influences and users'subjective perceptions, leading to limitations in the accuracy of thermal comfort prediction in real-world environments.

The thermal environment in cold-region pedestrian spaces exhibits significant temporal and spatial variations. As a result, the pedestrians' spatiotemporal movement during walking lead to fluctuations in the thermal environment, dynamically influencing their thermal perception and causing variations in skin temperature, which may elicit either positive or negative thermal sensations. However, current prediction methods do not adequately account for these influences.

Therefore, it is necessary to provide a method for generative design of a cold-region urban pedestrian space layout based on dynamic thermal comfort prediction, which ensures both the simulation fidelity and specificity of the spatial layout while offering efficient decision support to a designer for cold-region pedestrian space layout design.

### SUMMARY

The purpose of the present disclosure is to address the limitations of existing pedestrian thermal comfort prediction methods, including insufficient consideration of environmental variations and subjective perceptions, as well as low prediction accuracy. It aims to enhance the prediction accuracy of dynamic thermal comfort for pedestrians in cold-region urban pedestrian spaces, overcome the efficiency bottlenecks of existing prediction approaches, strengthen their supporting role in the preliminary design of cold-region pedestrian spaces, and establish a method for generative design of pedestrian space layout based on dynamic thermal comfort prediction, thereby resolving the inadequate integration of dynamic thermal comfort considerations in existing design decisions for cold-region urban and rural pedestrian spaces.

One or more embodiments of the present disclosure provide a method for generative design of a cold-region urban pedestrian space layout based on dynamic thermal comfort prediction. The method includes:
S1, constructing a wayfinding agent model in a cold-region pedestrian space;
the step S1 includes:
S1.1: collecting trajectory data of pedestrian groups during a plurality of travel periods in a typical cold-region pedestrian space based on Internet of Things (IoT) perception;
S1.2: constructing a wayfinding grey-box model during the plurality of travel periods in the cold-region pedestrian space;
S1.3: extracting pedestrian trajectories during the plurality of travel periods based on drone image data of the typical cold-region pedestrian space;
S1.4: calibrating the wayfinding agent model based on IoT perception data of the typical cold-region pedestrian space;
S2, constructing a mapping between thermal environment data of the cold-region pedestrian space and dynamic thermal comfort data of pedestrians;
the step S2 includes:
S2.1: obtaining pedestrian thermal sensation in the typical cold-region pedestrian space based on ecological momentary assessment (EMA);
S2.2: constructing a pedestrian thermal sensation model under winter and summer thermal environment conditions of the cold-region pedestrian space;
S2.3: calibrating the pedestrian thermal sensation model under the winter and summer thermal environment conditions of the cold-region pedestrian space based on reinforcement learning;
S3, generating a cold-region pedestrian space layout design driven by dynamic thermal comfort data;
the step S3 includes:
S3.1: obtaining a cold-region pedestrian space layout scheme driven by generative rules;
in step S3.1, obtaining and voxelizing layout model data of a cold-region block, applying a three-dimensional convolutional neural network to extract features of layout and building masses to obtain extracted features; dividing, based on scale features of the cold-region block, a predefined cold-region pedestrian space into three-dimensional units, performing constraint settings on a three-dimensional matrix based on design conditions of the cold-region pedestrian space and the extracted features so that a generated scheme meets a geometric and topological requirement, and under a constraint condition, allocating the three-dimensional units based on a multi-agent system to generate a cold-region pedestrian space layout, and obtaining a cold-region pedestrian space layout optimization prototype;
S3.2: optimizing the cold-region pedestrian space layout design driven by the dynamic thermal comfort data;
the step S3.2 includes:
S3.2.1: constructing a cold-region pedestrian space layout optimization model;
S3.2.2: obtaining the dynamic thermal comfort data of the pedestrians during travel periods under the cold-region pedestrian space layout;
S3.2.3: optimizing the cold-region pedestrian space layout oriented by the dynamic thermal comfort data;
S3.3: providing decision support for the cold-region pedestrian space layout design based on human-computer interaction;
in the step S3.3, after obtaining an optimal scheme of the cold-region pedestrian space layout oriented by the dynamic thermal comfort data, applying, based on dynamic thermal comfort data of the cold-region pedestrian space layout scheme and morphological evaluation data of the cold-region pedestrian space layout scheme by a designer, a random forest model to construct a cold-region pedestrian space layout decision model, and obtaining a preliminary decision scheme; applying a VR device and an environmental control device to provide users with a walking experience simulation of the cold-region pedestrian space layout scheme, obtaining evaluations of the cold-region pedestrian space layout scheme from the users, and using the evaluations as feedback for the cold-region pedestrian space layout decision model to further adjust the cold-region pedestrian space layout decision model, to provide decision support for the designer.

One or more embodiments of the present disclosure provide an electronic device. The electronic device includes a memory and a processor, wherein the memory stores a computer program, and the processor is configured to execute the computer program to implement the steps of the method for generative design of the cold-region urban pedestrian space layout based on dynamic thermal comfort prediction.

One or more embodiments of the present disclosure provide a non-transitory computer-readable storage medium for storing computer instructions, wherein the computer instructions, when executed by a processor, cause the processor to implement the steps of the method for generative design of the cold-region urban pedestrian space layout based on dynamic thermal comfort prediction.

### BRIEF DESCRIPTION OF THE DRAWINGS

The present disclosure will be further illustrated by way of exemplary embodiments, which will be described in detail with reference to the accompanying drawing. It will be obvious that the accompanying drawing in the following description illustrate only some of the embodiments of the present disclosure, and not all of the embodiments. For the person of ordinary skill in the art (POSITA), other accompanying drawings can be obtained according to these drawings under the premise of not exerting creative labor.

FIG. 1 is a flowchart illustrating an exemplary process for generative design of a cold-region urban pedestrian space layout based on dynamic thermal comfort prediction according to some embodiments of the present disclosure.

### DETAILED DESCRIPTION

The technical solutions in the embodiments of the present disclosure will be clearly and completely described below with reference to the accompanying drawing in the embodiments of the present disclosure. It should be understood that the described embodiments are only a part of the embodiments of the present disclosure, rather than all the embodiments. Based on the embodiments in the present disclosure, all other embodiments obtained by a person of ordinary skill in the art without undue experimentation shall fall within the protection scope of the present disclosure.

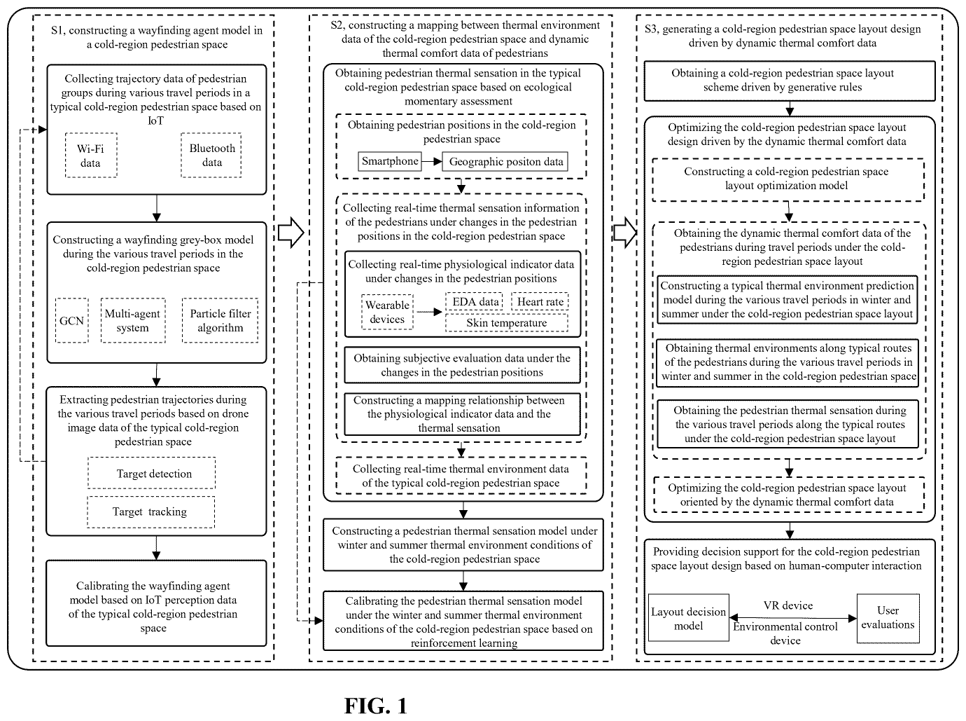

FIG. 1 is a flowchart illustrating an exemplary process for generative design of a cold-region urban pedestrian space layout based on dynamic thermal comfort prediction according to some embodiments of the present disclosure.

A method for generative design of a cold-region urban pedestrian space layout based on dynamic thermal comfort prediction (also referred to as a method for generating a layout design of a cold-region urban pedestrian space based on dynamic thermal comfort prediction), provided according to some embodiments of the present disclosure, may be executed by a processor. For example, the processor may be a central processing unit (CPU), a graphics processing unit (GPU), an application-specific integrated circuit (ASIC), or other hardware devices with computational capabilities. The processor may also include caches, registers, and other computational resources to increase processing efficiency. The processor may work in concert with other hardware components (e.g., memory, input/output interfaces) to accomplish data reading, processing, and output. The processor may perform a variety of computational tasks, including, but not limited to, data collection, feature extraction, model training, or the like. As shown in FIG. 1, the method may include the following steps.

### Step S1, Constructing a Wayfinding Agent Model in a Cold-Region Pedestrian Space

The cold-region pedestrian space refers to an outdoor space located in low-temperature environments of cold climate zones that is designed for pedestrian walking activities. The cold-region pedestrian space includes, but is not limited to, open-air pedestrian areas in high-latitude cities where winter temperatures fall below a temperature threshold (e.g., a daily average winter temperature below 0° C.), such as commercial pedestrian streets and urban squares.

The wayfinding agent model refers to a model configured to predict pedestrian trajectories in cold-region pedestrian spaces. The wayfinding agent model may be constructed based on one or more approaches (or a combination thereof), such as convolutional neural networks (CNN), graph neural networks (GNN), or other custom models.

In some embodiments, the step S1 includes step S1.1-step S1.4 to construct the wayfinding agent model.

### Step S1.1, Collecting Trajectory Data of Pedestrian Groups During a Plurality of Travel Periods in a Typical Cold-Region Pedestrian Space Based on IoT Perception

The typical cold-region pedestrian space refers to a representative cold-region pedestrian space. For example, the typical cold-region pedestrian space may be a representative cold-region pedestrian space where pedestrian flow exceeds a preset flow threshold (e.g., a pedestrian street, a commercial street). The preset flow threshold may be set according to actual needs.

The travel periods may be divided based on different time intervals within a day. For example, the travel periods may be 0:00-06:00, 6:00-12:00, 12:00-18:00, and 18:00-24:00. In some embodiments, the processor may set the travel periods based on a preset duration (e.g., 1 hour). For example, the travel periods may be 6:00-7:00, 7:00-8:00, . . . , 23:00-24:00. The travel periods may also be determined based on the actual situation of different cold-region pedestrian spaces. Merely by way of example, the travel periods may be determined according to the business hours of a commercial street or travel preferences of the pedestrian groups.

The trajectory data of pedestrian groups may be used to reflect changes in pedestrian positions in the cold-region pedestrian space during the plurality of travel periods. The trajectory data of pedestrian groups includes, but is not limited to, each travel period, a count of pedestrians corresponding to the travel period, device identification information of each pedestrian (e.g., a medium/media access control (MAC) address of an anonymized mobile phone), and position information (e.g., positional coordinates, latitudes and a longitudes) of each pedestrian at each time point (e.g., a timestamp).

In some embodiments, in step S1.1, the processor may select a subset of typical cold-region pedestrian spaces, to record, during the plurality of travel periods, device identification information (e.g., the MAC address) of each pedestrian and signal strength data of each pedestrian device through a plurality of Wi-Fi and Bluetooth access points or beacons deployed within a target region, and estimate positions and trajectories of each pedestrian device by triangulation and data fusion techniques, thereby achieving pedestrian positioning and trajectory tracking during the plurality of travel periods in the typical cold-region pedestrian space.

The target region refers to the geographical region corresponding to the typical cold-region pedestrian space. In some embodiments, a plurality of Internet of Things (IoT) devices may be deployed at preset positions within the target region. The preset positions may be determined based on actual conditions such as the spatial layout of the target region (e.g., building distribution), popular areas with high pedestrian flow, or dense areas. For example, the preset positions may include an entrance, an exit of the pedestrian street, a position near a certain store, or the like.

The plurality of IoT devices refers to various types of devices capable of collecting and/or sensing information related to the trajectory data of pedestrian groups. The plurality of IoT devices includes, but is not limited to, a Wi-Fi device, a Bluetooth device, an environmental data collection device (e.g., a temperature sensor), an image capture device (e.g., a camera), and a drone device (e.g., a drone). In some embodiments, the plurality of IoT devices may form an IoT network to enable interaction of data (e.g., IoT data collected by the plurality of IoT devices) and/or information.

In some embodiments, in the step S1.1, the processor may select a typical cold-region pedestrian space as a research region (i.e., the target region), where a plurality of Wi-Fi and Bluetooth access points or beacons are deployed. The spacing between the access points may be determined based on environmental conditions (e.g., meteorological factors, building distribution) and positioning accuracy requirements to ensure signal coverage across the entire target region.

During the plurality of travel periods, the processor may record the MAC addresses and the signal strength data of all pedestrian devices (e.g., mobile phones) entering the target region. In some embodiments, the processor may obtain the MAC addresses and signal strength data of pedestrian devices entering the target region by the plurality of Wi-Fi and Bluetooth access points periodically scanning their signal coverage range. The obtained MAC addresses and the signal strength data may be stored in a database. Each record may include information such as a timestamp, an access point ID, the MAC address of the pedestrian device, and the signal strength data to facilitate subsequent data processing and analysis.

The signal strength data may include values of received signal strength indication (RSSI) of the pedestrian device detected by the plurality of Wi-Fi and Bluetooth access points. The value(s) of RSSI (also referred to as signal strength) may be used to estimate a distance between each access point (e.g., the Wi-Fi access point) and the pedestrian device, thereby determining a position of the pedestrian device.

In some embodiments, the processor may determine the position of the pedestrian device using triangulation techniques based on the signal strength received from the same device by different access points.

In some embodiments, the processor may convert the value of RSSI into a distance using a path loss model, and determine the position of the pedestrian device via a triangulation algorithm based on the converted distance and the positions of the access points. In some embodiments, the path loss model includes, but is not limited to a free-space path loss (FSPL) model, an international telecommunication union indoor path loss (ITU Indoor Path Loss) model.

In some embodiments, considering that signals in cold-region pedestrian spaces are affected by unpredictable and differential obstacles (e.g., a wall, furniture), a more flexible empirical path loss model is adopted to improve the accuracy of the determined pedestrian device position. This path loss empirical model is represented by the following formula (1):

$$RSSI = {RSSI}_{0} - 10 n {log}_{10} ( d ) , \qquad ( 1 )$$

where RSSI denotes the value of RSSI, measured in dBm, RSSI₀ denotes the signal strength at a reference distance d₀, which is determined based on the signal strength measured at the reference distance d₀ of 1 meter, d is the distance between the receiver (e.g., the Wi-Fi and Bluetooth access point) and the transmitter (e.g., the pedestrian device), measured in meters (m), n is a path loss exponent, and its value may be set between 2 and 4 based on environmental conditions.

In some embodiments, after determining a plurality of positions of each pedestrian device in the target region, the processor may determine a trajectory of each pedestrian device during the plurality of travel periods based on the plurality of positions of the pedestrian devices, timestamps corresponding to the plurality of positions, and the MAC addresses of the pedestrian devices. For example, for a given MAC address of the pedestrian device, the trajectory corresponding to the pedestrian device may be generated from the plurality of positions of the pedestrian device during a plurality of travel periods in a chronological order based on the timestamps. It should be understood that the trajectory corresponding to the pedestrian device represents the pedestrian trajectory.

### Step S1.2, Constructing a Wayfinding Grey-Box Model During Each of the Plurality of Travel Periods in the Cold-Region Pedestrian Space

In some embodiments, in step S1.2, pedestrian trajectory data may be converted into a pedestrian path graph. A pedestrian path selection model is constructed based on a graph convolutional network (GCN) model to predict the selection of path nodes by pedestrians. Furthermore, a pedestrian wayfinding grey-box model is constructed by integrating a social force model, a multi-agent system, and a particle filter algorithm. Parameters of the pedestrian wayfinding grey-box model are optimized and adjusted based on the pedestrian trajectory data. In some embodiments of the present disclosure, pedestrian trajectory prediction is achieved by integrating mathematical models (e.g., the social force model, the multi-agent system, and the particle filter algorithm) with data-driven methods (e.g., the GCN-based pedestrian path selection model).

The pedestrian path selection model may be configured to predict a probability of a movement of the pedestrian from a current position to a next position. In some embodiments, the pedestrian path selection model is a trained GCN model. It is understood that movements of pedestrians in cold-region pedestrian space involve a degree of subjectivity or randomness, and such subjectivity is influenced by actual conditions of the cold-region pedestrian space. For example, the movements of pedestrians may be affected by a distribution of different stores within the cold-region pedestrian space due to shopping needs of the pedestrians. As another example, pedestrian movements may also be influenced (e.g., aggregation or dispersion) by pedestrian flow.

The pedestrian path graph refers to a topological graph representing pedestrian trajectories, which may be constructed based on spatial information of the cold-region pedestrian space (e.g., building distribution). The pedestrian path graph includes a plurality of path nodes and a plurality of path edges. The path nodes may be defined based on key positions within the cold-region pedestrian space. The key positions may include points of interest (e.g., a coffee shop, a department store, etc.) and other physical points (e.g., an intersection, an exit, an entrance). Two adjacent path nodes are connected to form a path edge, which represents a pathway between two key positions (i.e., a movement path for the pedestrians).

In some embodiments, attributes of the path node of the pedestrian path graph include position information (e.g., a positional coordinate), a position label (e.g., P1, P2), or the like. Attributes of the path edge of the graph include a pedestrian flow volume, a movement duration, or the like. The attributes of the path edge may also include an edge weight, which may be determined based on the attributes of the path edge, such as the pedestrian flow volume and the movement duration. For example, when the path edge weight represents preference level, a higher pedestrian flow volume may correspond to a higher edge weight; when the edge weight represents traversal cost, a longer movement duration may result in a higher edge weight. The manner for setting the edge weight may be adjusted according to actual requirements. The examples provided here are for illustrative purposes only, and the edge weight may also be manually preset based on experience.

In some embodiments of the present disclosure, the pedestrian path graph can accurately reflect the aggregation and/or dispersion preferences of the pedestrian groups in the cold-region pedestrian space during different travel periods, thereby providing a foundation for predicting subsequent pedestrian trajectory information, such as movement direction and selection of key positions.

The social force model is configured to simulate interaction forces between pedestrians and environmental influences on the pedestrians. The multi-agent system is configured to simulate collective behaviors and path selection strategies of the pedestrians. The particle filter algorithm is configured for real-time tracking and prediction of the pedestrian trajectories. In some embodiments, the wayfinding grey-box model may be generated by integrating the pedestrian path selection model, the social force model, the multi-agent system, and the particle filter algorithm.

In some embodiments, in step S1.2, the collected pedestrian trajectory data may be preprocessed. The preprocessing operation includes removing noise, filling missing data, and standardization. The preprocessed pedestrian trajectory data may be converted into the pedestrian path graph.

Merely by way of example, for a pedestrian path graph corresponding to a certain cold-region pedestrian space, the processor may generate a pedestrian flow attribute for each path edge based on preprocessed pedestrian trajectory data corresponding to a certain travel period. This pedestrian path graph may serve as one graph sample for the certain travel period. For the certain travel period, the processor may generate a plurality of pedestrian path graph samples from the pedestrian trajectory data collected over historical periods (e.g., a past week, a past month) to obtain a pedestrian path graph sample set. The pedestrian path graph sample set is used for subsequent training of the pedestrian path selection model.

During training, the processor may input each graph sample into the pedestrian path selection model, which outputs a selection probability of each node being selected. The selection probability reflects the movement preference of pedestrians on the route path corresponding to the path edge. For example, the selection probabilities of a pedestrian selecting the two nodes connected by a path edge may be 0.2 and 0.8, respectively. The training process of the pedestrian path selection model includes feature extraction, graph convolution operations, and node classification. Through a plurality of iterative optimizations, the prediction accuracy and robustness of the model can be improved.

Furthermore, a pedestrian wayfinding grey-box model is constructed by integrating the social force model, the multi-agent system, and the particle filter algorithm.

In some embodiments, during construction of the wayfinding grey-box model, an initial position and velocity are first assigned to each agent to simulate the initial state of the pedestrian group. The initial states reflect the position and movement direction of pedestrians at a specific time point. Then, a set of particles is initialized for each agent, where the particles represent possible trajectory states. The particle filter algorithm uses these particles to represent possible future positions and movement paths of pedestrians over subsequent time steps.

After the initialization is completed, the trained pedestrian path selection model is used to predict the selection probability of each node being selected, thereby predicting the next target node of the actual pedestrian trajectory. The target node is the path node with the highest selection probability, which provides a clear short-term goal for each agent and offers direction for subsequent motion computation. Thereafter, the motion of each agent at a current time step is determined based on the social force model. The social force model may determine the acceleration and velocity change of the pedestrians by considering interaction forces between the pedestrians, attractive forces between the pedestrians and their targets (e.g., points of interest), and repulsive forces between the pedestrians and obstacles, thereby updating the positions of the pedestrians.

Furthermore, the particle filter algorithm is applied to predict and track the trajectories of the agents. The particle filter utilizes the social force model to predict the motion path of each particle, while adjusting a weight of each particle by incorporating actual observation data. Through weight adjustment, the particle filter can improve the estimation accuracy of the pedestrian trajectory. The resampling step can enhance the reliability of trajectory prediction by selecting particles with higher weights, thereby reducing improbable trajectories.

The states of the agents may be updated based on the results of the particle filter algorithm. This process ensures that the trajectory of each agent not only accurately reflects its own motion patterns but also remains consistent with real-world interactions with the environment and other pedestrians. Through such dynamic adjustments, the motion trajectory of each agent becomes more precise and reliable.

Finally, through continuous iteration of the above steps, the trajectories of the agents are gradually optimized and accurately predicted. In each time step, the trajectory of an agent is adjusted and optimized based on new observation data and the prediction results of the particle filter algorithm until predictions for all time steps are completed, resulting in the final pedestrian wayfinding grey-box model.

### Step S1.3, Extracting Pedestrian Trajectories During the Plurality of Travel Periods Based on Drone Image Data of The Typical Cold-Region Pedestrian Space

In step S1.3, based on low-altitude drone photography, multi-angle image data of the typical cold-region pedestrian space is acquired during the plurality of time periods. A high-precision 3D information model of the cold-region block is constructed from the multi-angle image data, and pedestrian positions in key frames are annotated within this high-precision 3D information model. Simultaneously, the YOLO algorithm is applied to perform object detection in consecutive drone image frames, and the tracking algorithm is used to individually track each detected pedestrian to obtain their positional changes. The pedestrian trajectories are then high-accuracy reconstructed by integrating the pedestrian positions from the key frames with the pedestrian position change information.

In some embodiments, in step S1.3, a drone is deployed within the typical cold-region pedestrian space, and a flight path of the drone is planned based on a terrain and layout of the target region to ensure full coverage of the entire region. In some embodiments, the processor controls the drone to perform multiple low-altitude flights during the plurality of travel periods (e.g., 08:00-09:00, 09:00-10:00, 10:00-11:00, 11:00-12:00, 12:00-13:00, 13:00-14:00, 14:00-15:00, 15:00-16:00, 16:00-17:00, and 17:00-18:00). The drone is equipped with a high-resolution camera device to capture multi-angle image data, ensuring clarity and coverage of the imagery while avoiding obstructions and motion blur.

The flight path of the drone may be planned by Altizure software. After the survey area, altitude, forward overlap, side overlap, and camera tilt angle are planned, the shooting time may be automatically determined by the Altizure software.

Subsequently, the multi-angle image data captured by the drone is preprocessed, including noise removal and color correction. The preprocessed multi-angle image data is then imported into ContextCapture Master software to perform image matching of homologous points across a plurality of data sources. By setting tie points and ground control points (GCPs), a correction equation is established to improve the accuracy of image matching.

During the modeling process, the optimal images of each position from different angles are automatically matched. The Semi-Global Matching (SGM) algorithm is used for feature point matching, converting multi-angle image data into point cloud data. After segmenting the dense point cloud data obtained through aerial triangulation, triangulated irregular network (TIN) meshes of different levels are generated to transform the point cloud data into an irregular triangular mesh model. The irregular triangular mesh model is then simplified, and after automatic texture mapping, a high-precision 3D information model of the target region is generated. This ensures the accuracy and details of the model, enabling it to clearly display such information as the terrain, buildings, and roads in the target region.

Furthermore, a plurality of typical frames are selected from the multi-angle image data captured by the drone. The plurality of typical frames may represent the pedestrian distribution of the target region during different travel time periods. Then, the position of each pedestrian is located in the selected typical frames, and these position data are recorded in the high-precision 3D information model.

Afterwards, an object recognition model (e.g., a You Only Look Once (YOLO) model) is trained using a public pedestrian detection dataset or a custom dataset, enabling it to accurately detect pedestrian targets in the multi-angle image data captured by the drone. The trained YOLO model is applied to continuous drone image frames to automatically detect the pedestrian targets in the drone image frames and record the position and time information of each pedestrian.

In some embodiments, the processor may construct a tracker using a tracking algorithm to track each pedestrian target. The tracking algorithm may be the discriminative correlation filter with channel and spatial reliability (CSRT) algorithm. The processor may construct a CSRT tracker based on the CSRT algorithm to individually track each detected pedestrian, thereby obtaining changes in their positions. In some embodiments, the tracking algorithm may be the ByteTrack algorithm. For the positions of a plurality of detected pedestrian targets (e.g., pedestrian positions in a first image frame), the processor constructs a multi-object tracker using the ByteTrack algorithm to simultaneously track subsequent positional changes of the plurality of detected pedestrian targets. In some embodiments, the multi-object tracker (i.e., the ByteTrack tracker) may perform data association based on object detection results (e.g., the positions of the plurality of detected pedestrian targets detected by the YOLO model) and appearance features (e.g., the appearance features of the plurality of detected pedestrian targets detected by the YOLO model), enabling individual tracking of each pedestrian across consecutive drone image frames and recording the positional change information of each pedestrian over a plurality of consecutive frames.

Finally, the manually annotated pedestrian positions from key frames and the pedestrian positional change information obtained via the ByteTrack algorithm are integrated and fused into the high-precision 3D information model. Herein, key frames refer to image frames selected from the image sequence and annotated with pedestrian positions, which can be used to correct errors in the pedestrian positions detected by the ByteTrack tracker. Based on the integrated pedestrian position data, a trajectory reconstruction algorithm is used to perform high-accuracy reconstruction of pedestrian movement trajectories, ensuring that the reconstructed trajectories accurately reflect the movement paths and behavioral patterns of pedestrians within the cold-region pedestrian space. The reconstructed pedestrian trajectories are visualized within the high-precision 3D information model through a Geographic Information System (GIS) platform or 3D visualization tools, providing intuitive analytical results of pedestrian behavior.

### Step S1.4, Calibrating the Wayfinding Agent Model Based on IoT Perception Data of the Typical Cold-Region Pedestrian Space

The IoT perception data refers to data collected by the IoT devices. In some embodiments, the IoT perception data used to calibrate the wayfinding agent model includes the drone image data. For example, the wayfinding agent model may be calibrated using the pedestrian trajectories extracted from the drone image data during the plurality of travel periods.

In some embodiments, the processor may use data of the pedestrian trajectories during the plurality of travel periods in the typical cold-region pedestrian space as a fine-tuning dataset to further train the wayfinding grey-box model corresponding to each travel period. The parameters of the wayfinding grey-box model are gradually adjusted and optimized to obtain the wayfinding agent model for each travel period. The adjustment and optimization of the parameters of the wayfinding grey-box model include modifying one or a combination of the following: the model parameters of the pedestrian path selection model (e.g., edge weights/cost coefficients), parameters of the social force model (e.g., desired speed, relaxation time, “repulsive force strength and range”), parameters of the multi-agent system (e.g., perception radius), and parameters of the particle filter algorithm (e.g., a count of particles, process noise, observation noise).

In some embodiments of the present disclosure, a wayfinding agent model for the cold-region pedestrian space is constructed based on big data and IoT data, enabling more efficient acquisition of pedestrian trajectories during the plurality of travel periods in the cold-region pedestrian spaces with different spatial layouts.

### Step S2, Constructing a Mapping Between Thermal Environment Data of the Cold-Region Pedestrian Space and Dynamic Thermal Comfort Data of Pedestrians

In some embodiments, the step S2 includes step S2.1-step S2.3.

S2.1: obtaining pedestrian thermal sensation in the typical cold-region pedestrian space based on ecological momentary assessment.

The step S2.1 includes step S2.1.1-step S2.1.3.

### Step S2.1.1, Obtaining Pedestrian Positions in the Cold-Region Pedestrian Space

In some embodiments, a geographic position of the pedestrian is recorded in real time based on a mobile device (e.g., a smartphone, etc.) carried by the pedestrian, thereby obtaining the pedestrian positions in the cold-region pedestrian space.

### Step S2.1.2, Collecting Real-Time Thermal Sensation Information of the Pedestrians Under Changes in the Pedestrian Positions in the Cold-Region Pedestrian Space

In some embodiments, in step S2.1.2, real-time skin temperature, heart rate, and electrodermal activity (EDA) data under the changes in the pedestrian positions are collected based on wearable devices, and subjective evaluation data under the changes in the pedestrian positions are obtained. In some embodiments, the processor may construct a mapping relationship between physiological indicator data and the thermal sensation of the pedestrians in the cold-region pedestrian space to obtain the real-time thermal sensation information of the pedestrians under the changes in the pedestrian positions in the cold-region pedestrian space.

The wearable devices include smart wearable ear-clip sensors, wrist sensors, and finger sensors. The wearable devices may be used to collect the physiological indicator data of the pedestrians under the changes in the pedestrian positions in the cold-region pedestrian space. The physiological indicator data include, but are not limited to, the real-time skin temperature, heart rate, and EDA data of the pedestrians. The wearable devices may transmit the physiological indicator data to a central data processing server via wireless communication (e.g., Bluetooth or Wi-Fi).

The real-time thermal sensation information refers to the subjective evaluation data provided by the pedestrians regarding their current thermal sensation. The subjective evaluation data include subjective indicators such as thermal acceptability, thermal comfort, warm/cold perception, and thermal pleasure. The real-time thermal sensation information may be collected via questionnaires administered during pedestrian walking. In some embodiments, the processor may match the thermal sensation information with physiological indicator data in time and space to form a complete dataset.

In some embodiments, the processor may construct the mapping relationship between the physiological indicator data and the thermal sensation of the pedestrians by big data analytics and machine learning techniques. In some embodiments, physiological features such as skin temperature change rate, heart rate fluctuation patterns, and EDA signal variations are extracted as input variables, with the corresponding thermal sensation serving as the output, thereby building a mapping model from user physiological indicators to subjective thermal sensation. This mapping relationship can be implemented in various forms (e.g., mathematical models or machine learning models). First, the collected data are cleaned and normalized to remove noise and outliers. Then, physiological features corresponding to the pedestrian physiological indicator data, such as skin temperature change rate, heart rate fluctuation patterns, and EDA signal variations, are extracted as input variables for the mapping relationship, with the output being the thermal sensation corresponding to the physiological features.

In some embodiments, a neural network model may be used to construct a mapping model from user physiological indicators to subjective thermal sensation. After validating and optimizing the constructed mapping model, real-time prediction of pedestrian thermal sensation in cold-region pedestrian spaces based on physiological signals is achieved.

### Step S2.1.3, Collecting Real-Time Thermal Environment Data of the Typical Cold-Region Pedestrian Space

The real-time thermal environment data are used to reflect current environmental conditions in the cold-region pedestrian space. The thermal environment data include, but are not limited to, air temperature, humidity, wind speed, and other metrics, which can be collected through various corresponding sensing devices. In some embodiments, the thermal environment data may be in the form of images (e.g., heat maps). For example, the thermal environment data may consist of thermal images, where colors at different positions in the image represent environmental conditions (e.g., temperature distribution) in different physical regions of the cold-region pedestrian space.

### Step S2.2, Constructing a Pedestrian Thermal Sensation Model Under Winter and Summer Thermal Environment Conditions of the Cold-Region Pedestrian Space

The pedestrian thermal sensation model may be constructed based on machine learning algorithms and may be used to predict the thermal sensation of pedestrians in different thermal environments during the plurality of travel periods in winter and summer. In some embodiments, thermal environment data such as wind speed, temperature, and solar radiation intensity collected by the aforementioned methods serve as input variables, while users' subjective thermal sensation evaluations (e.g., TSV/TCV/TPV) obtained based on physiological indicators via the aforementioned methods serve as outputs, thereby constructing a mapping model from the thermal environment to user subjective thermal sensation and achieving prediction of pedestrian thermal sensation under winter and summer thermal environment conditions.

### Step S2.3, Calibrating the Pedestrian Thermal Sensation Model Under the Winter and Summer Thermal Environment Conditions of the Cold-Region Pedestrian Space Based on Reinforcement Learning

In some embodiments, the processor may utilize a trial-and-error mechanism of reinforcement learning (RL) to enable autonomous learning and calibration of the pedestrian thermal sensation model based on the collected physiological indicator data, pedestrian thermal sensation data, and real-time thermal environment data. For example, by taking environmental features and individual features (e.g., physiological features of pedestrians) as input, and using the discrepancy between prediction results and actual thermal sensation as a reward signal, the processor learns an optimal strategy by maximizing cumulative rewards. This process dynamically adjusts the parameters of the pedestrian thermal sensation model, thereby yielding a calibrated model for predicting pedestrian thermal sensation under winter and summer thermal environment conditions.

In some embodiments of the present disclosure, the calibrated pedestrian thermal sensation model can more accurately predict the thermal perception of pedestrians in a cold-region pedestrian space. While ensuring prediction fidelity and specificity, it also improves the efficiency of data processing and model updating.

### Step S3, Generating a Cold-Region Pedestrian Space Layout Design Driven by Dynamic Thermal Comfort Data

The cold-region pedestrian space layout reflects the overall spatial pattern and element distribution of a pedestrian block. Elements of the cold-region pedestrian space layout include the road system (e.g., a main street, a branch road, an intersection, and their connectivity and width), building massing and arrangement (height, spacing, setback, orientation, density), as well as open spaces (squares, pocket parks, green spaces). These macroscopic morphological features of the cold-region pedestrian space layout determine wind environment and sunlight/shading conditions of the cold-region pedestrian space, thereby influencing outdoor thermal comfort and thermal pleasure experience of the pedestrians.

The cold-region pedestrian space layout design or scheme includes layout features, building mass features, and open space features. The layout features characterize geometric and topological attributes of a road network, including the number, morphology, alignment, curvature, width, length, and connectivity of roads. The layout features determine the ventilation corridors and sunlight conditions of the block. The building mass features may represent a spatial form and an arrangement of building groups, including the type, quantity, height, number of stories, volume, spacing, and orientation of buildings. The building mass features have a direct impact on the organization of the wind environment and regulation of the thermal environment. The open space features represent the area and distribution of open spaces (e.g., a square, a park), and the relationship between the open spaces and buildings and roads. The open space features may improve sunlight access, reduce wind chill effects, and provide thermally comfortable activity spaces for pedestrians.

In some embodiments, the step S3 includes step S3.1-step S3.3.

### Step S3.1: Obtaining a Cold-Region Pedestrian Space Layout Scheme Driven by Generative Rules

The generative rules refer to sets of design criteria or conditions used to constrain and guide the formation of spatial morphology during the generative process of the cold-region pedestrian space layout. The generative rules may be defined according to different design objectives and practical requirements. For example, the generative rules may include planning regulations, functional and circulation organization needs, architectural aesthetic considerations, as well as microclimate and thermal comfort optimization goals. In some embodiments, the generative rules may include, but are not limited to, the following categories: building control rules (e.g., building density, floor area ratio, height restrictions, setback requirements, massing, and alignment), road network rules (e.g., road width, orientation, connectivity, intersection morphology, and guidance), open space rules (e.g., area ratio and distribution location of the open spaces, spatial relationship between buildings and roads and the open spaces).

In step S3.1, obtaining and voxelizing layout model data of a cold-region block, applying a three-dimensional convolutional neural network to extract features of layout and building masses to obtain extracted features; dividing, based on scale features of the cold-region block, a predefined cold-region pedestrian space into three-dimensional units, performing constraint settings on a three-dimensional matrix based on design conditions of the cold-region pedestrian space and the extracted features so that a generated scheme meets a geometric and topological requirement, and under a constraint condition, allocating the three-dimensional units based on a multi-agent system to generate a cold-region pedestrian space layout, and obtaining a cold-region pedestrian space layout optimization prototype.

The layout model data of a cold-region block refers to input data that reflects the spatial configuration of a target cold-region block, including road network morphology, building height and volume, building spacing, and open space distribution. The layout model data may be obtained from design drawings, 3D models, or field-measured data. Scale features are used to represent spatial scale relationships within the block—such as road width, street canyon height-to-width ratio (H/W), building height distribution, and density metrics—which collectively reflect the environmental attributes of the block at a pedestrian scale.

In some embodiments, step 3.1 includes: first obtaining a large amount of cold-region block layout model data and voxelizing this layout model data, i.e., discretizing the three-dimensional model into a plurality of three-dimensional units. The size of these units should balance design accuracy and computational efficiency to ensure that block spatial features are reflected at an acceptable resolution. Subsequently, geometric and topological constraints are applied to the three-dimensional unit matrix based on the design conditions of the cold-region pedestrian space and the extracted layout features. These constraints include, but are not limited to, building height and volume restrictions, road width and connectivity requirements, adjacency between blocks and roads, building density and setback controls, as well as performance metrics that meet demands for sunlight, wind environment, and thermal comfort.

Under these constraints, the three-dimensional units are allocated based on a multi-agent system, where different spatial functions or building types are abstracted as agents that select and compete within the three-dimensional unit matrix according to predefined rules, thereby achieving spatial filling and combination. During the iterative process, each agent interacts and adjusts based on design conditions and constraints, including conflict avoidance, connectivity maintenance, and performance objective optimization. Through a plurality of rounds of iterative optimization, a cold-region pedestrian space layout design scheme that conforms to the geometric and topological constraints and meets thermal comfort optimization requirements is gradually formed, fulfilling the design objectives.

### Step S3.2, Optimizing the Cold-Region Pedestrian Space Layout Design Driven by the Dynamic Thermal Comfort Data

In some embodiments, the step S3.2 includes step S3.2.1-step S3.2.3.

### Step S3.2.1, Constructing a Cold-Region Pedestrian Space Layout Optimization Model

In some embodiments, in step 3.2.1, the processor may construct a mathematical model and a parametric model for optimizing the cold-region pedestrian space layout based on design objectives and constraints.

### Step S3.2.2, Obtaining the Dynamic Thermal Comfort Data of the Pedestrians During Travel Periods Under the Cold-Region Pedestrian Space Layout

The dynamic thermal comfort data of the pedestrians include environmental data (e.g., air temperature, wind speed, humidity, solar radiation intensity) under the cold-region pedestrian space layout and pedestrian thermal sensation data (e.g., thermal comfort level, warm/cold perception, thermal pleasure). The dynamic thermal comfort data of the pedestrians may reflect the subjective walking experience of the pedestrians under the current spatial layout.

In some embodiments, the step S3.2.2 includes step S3.2.2.1-step S3.2.2.3.

### Step S3.2.2.1, Constructing a Typical Thermal Environment Prediction Model During the Plurality of Travel Periods in Winter and Summer Under the Cold-Region Pedestrian Space Layout

In some embodiments, the processor may construct the typical thermal environment prediction model during the plurality of travel periods in winter and summer under the cold-region pedestrian space layout based on a convolutional neural network (CNN) model.

In some embodiments, the step S3.2.2.1 includes: obtaining thermal environment images during the plurality of travel periods in winter and summer under the cold-region pedestrian space layout, clustering the thermal environment images for the plurality of travel periods, respectively, to obtain clustered images, and then constructing a mapping relationship between the cold-region pedestrian space layout and the clustered images for the plurality of travel periods in winter and summer.

In some embodiments, the processor may perform microclimate simulation for 1000 typical cold-region pedestrian spaces using ENVI-MET software to obtain the thermal environment images during the plurality of travel periods in winter and summer in the cold-region pedestrian space. A data field may include two-dimensional distribution results of physical parameters (e.g., temperature, wind speed, relative humidity, and radiant temperature).

In some embodiments, the processor may preprocess the obtained thermal environment data fields. Preprocessing includes operations such as noise removal, normalization, and grid unification to achieve comparability across different spatial scales and time periods. Subsequently, a clustering algorithm (e.g., DBSCAN) is applied to analyze the thermal environment data fields, identifying at least one representative typical thermal environment pattern. The typical thermal environment pattern may be used to characterize the microclimate features of the cold-region pedestrian space during different travel periods.

Furthermore, spatial layout features of the cold-region block are extracted (e.g., building height, volume, spacing, street canyon height-to-width ratio H/W, road width and connectivity, open space ratio). A convolutional neural network (CNN) is constructed and trained, the spatial layout features of the cold-region block are used as input to the CNN, and the clustered typical thermal environment pattern is used as an output label, thereby establishing a mapping relationship between the cold-region pedestrian space layout and the thermal environment distribution. This enables rapid prediction of the thermal environment distribution under different cold-region pedestrian space layouts during the plurality of travel periods in winter and summer.

### Step S3.2.2.2, Obtaining Thermal Environments Along Typical Routes of the Pedestrians During the Plurality of Travel Periods in Winter and Summer in the Cold-Region Pedestrian Space

In some embodiments, the processor may obtain typical thermal environment images for the plurality of travel periods in winter and summer using the typical thermal environment prediction model constructed in step 3.2.1. Additionally, the processor may obtain pedestrian routes (i.e., pedestrian trajectories) during each travel period under the current cold-region pedestrian space layout using the wayfinding agent model constructed in step 1, thereby achieving prediction of the thermal environment along typical pedestrian routes during the travel periods in winter and summer in the cold-region pedestrian space.

### Step S3.2.2.3: Obtaining the Pedestrian Thermal Sensation During the Plurality of Travel Periods Along the Typical Routes Under the Cold-Region Pedestrian Space Layout

In some embodiments, the processor may obtain pedestrian thermal sensation during travel periods along typical routes under the cold-region pedestrian space layout. This is achieved by utilizing the thermal environment data along typical pedestrian routes during travel periods in winter and summer obtained in step 3.2.2, and processing it through the mapping model between thermal environment data and pedestrian thermal sensation in cold-region pedestrian space constructed in step 2.

### Step S3.2.3, Optimizing the Cold-Region Pedestrian Space Layout Oriented by the Dynamic Thermal Comfort Data

In some embodiments, the processor may apply a multi-objective optimization algorithm to optimize the cold-region pedestrian space layout based on a pedestrian dynamic thermal comfort objective, thereby obtaining a Pareto-optimal solution and consequently deriving an optimal cold-region pedestrian space layout scheme that satisfies the Pareto-optimal solution.

### Step S3.3, Providing Decision Support for the Cold-Region Pedestrian Space Layout Design Based on Human-Computer Interaction

The decision support for the cold-region pedestrian space layout design may be used to optimize and adjust the cold-region pedestrian space layout (scheme) of the cold-region pedestrian space.

In some embodiments, in the step S3.3, after obtaining an optimal scheme of the cold-region pedestrian space layout oriented by the dynamic thermal comfort data, applying, based on dynamic thermal comfort data of the cold-region pedestrian space layout scheme and morphological evaluation data of the cold-region pedestrian space layout scheme by a designer, a random forest model to construct a cold-region pedestrian space layout decision model, and obtaining a preliminary decision scheme; applying a VR device and an environmental control device to provide users with a walking experience simulation of the cold-region pedestrian space layout scheme, obtaining evaluations of the cold-region pedestrian space layout scheme from the users, and using the evaluations as feedback for the cold-region pedestrian space layout decision model to further adjust the cold-region pedestrian space layout decision model, to provide efficient and comprehensive decision support for the designer.

The cold-region pedestrian space layout decision model (hereinafter referred to as the layout decision model) refers to a model used to generate a cold-region pedestrian space layout scheme. In some embodiments, the layout decision model is a trained machine learning model (e.g., a random forest model).

In some embodiments, 200 designers are invited to evaluate and score the morphology of 1000 cold-region pedestrian space layout schemes, and a layout score for each layout scheme is obtained. The corresponding dynamic thermal comfort data for each layout scheme is also obtained. The obtained dynamic thermal comfort data is cleaned to remove noise and outliers. The dynamic thermal comfort data and morphological evaluation data (e.g., layout scores) are integrated into a comprehensive dataset to serve as training data for the layout decision model.

In some embodiments, key features are extracted from the comprehensive dataset. Statistical analysis and correlation analysis algorithms are used to select features with a significant influence on layout decision, thereby improving training efficiency and prediction accuracy of the layout decision model. A random forest model is then trained on the processed data to construct a preliminary layout decision model. The performance of the model is evaluated through cross-validation approaches to ensure it exhibits good generalization capability and predictive accuracy.

In some embodiments, the VR devices and the environmental control devices are used to provide users (e.g., participants) with a walking experience simulation of spatial layout schemes. High-performance VR headsets and controllers are selected to ensure an immersive walking experience for users, while the environmental control devices, such as an air conditioner and a humidifier, are configured to regulate temperature, humidity, and wind speed, simulating real climatic conditions and environmental variations. Three-dimensional modeling software is employed to construct a virtual scene of the cold-region pedestrian space layout scheme, including elements such as buildings, roads, and green spaces. Users are then invited to wear the VR device and participate in the virtual walking experience. During this process, environmental parameters in the virtual scene and the controllable environment are set based on the pedestrian dynamic thermal comfort data of the spatial layout scheme to simulate a realistic thermal comfort experience. User evaluations of the scheme, including feedback on comfort, aesthetics, and functionality, are recorded both during and after the experience and compiled into a structured evaluation dataset.

In some embodiments, the collected experience evaluation data are used to optimize and train the machine learning model by adjusting the parameters and optimization strategies of the preliminary layout decision model. This process gradually improves the decision accuracy and alignment of the layout decision model, resulting in an optimized version. Based on the optimized layout decision model, the optimal cold-region pedestrian space layout design scheme is obtained, providing the designer with efficient and comprehensive decision support.

In some embodiments of the present disclosure, the cold-region pedestrian space layout is optimized based on the predicted pedestrian thermal sensation along typical routes during the plurality of time periods. By incorporating machine learning models and the designer's decision feedback on visual solutions, a design decision model for the cold-region pedestrian space layout guided by the designer's preferences can be obtained. For decision-making regarding the cold-region pedestrian space layout, this approach ensures decision stability while accounting for designer preferences, making it more suitable for practical engineering applications.

One or more embodiments of the present disclosure provide an electronic device. The electronic device includes a memory and a processor. The memory stores a computer program, and the processor is configured to execute the computer program to implement the steps of the method for generative design of the cold-region urban pedestrian space layout based on dynamic thermal comfort prediction.

One or more embodiments of the present disclosure provide a non-transitory computer-readable storage medium for storing computer instructions, wherein the computer instructions, when executed by a processor, cause the processor to implement the steps of the method for generative design of the cold-region urban pedestrian space layout based on dynamic thermal comfort prediction.

The memory provided in some embodiments of the present disclosure may be volatile memory, non-volatile memory, or include both. Among them, non-volatile memory may be read-only memory (ROM), programmable read-only memory (PROM), erasable programmable read-only memory (EPROM), electrically erasable programmable read-only memory (EEPROM), or flash memory. Volatile memory may be random access memory (RAM), which serves as main memory. By way of illustrative but non-limiting examples, many forms of RAM are available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), and direct rambus DRAM (DRDRAM). It should be noted that the memory of the methods described in some embodiments is intended to include, but is not limited to, these and any other suitable types of memory.

In the foregoing embodiments, the described functionality may be implemented wholly or partially through software, hardware, firmware, or any combination thereof. When implemented in software, the functionality may be provided wholly or partially in the form of a computer program product. The computer program product includes one or more computer instructions. When the computer instructions are loaded and executed on a computer, the processes or functions described in the embodiments of this application are generated in whole or in part. The computer may be a general-purpose computer, a specialized computer, a computer network, or other programmable apparatus. The computer instructions may be stored in or transmitted from one computer-readable storage medium to another computer-readable storage medium. For example, the computer instructions may be transmitted from a website, computer, server, or data center to another website, computer, server, or data center by wired means (e.g., coaxial cable, optical fiber, digital subscriber line (DSL)) or wireless means (e.g., infrared, radio, microwave, etc.). The computer-readable storage medium may be any available medium that can be accessed by a computer or a data storage device such as a server or data center that integrates one or more available media. The available medium may be a magnetic medium (e.g., floppy disk, hard disk, magnetic tape), an optical medium (e.g., digital video disc (DVD)), or a semiconductor medium (e.g., solid state drive (SSD)), among others.

During implementation, the steps of the above method may be accomplished through integrated logic circuits of hardware in a processor or instructions in the form of software. The steps of the methods disclosed in the embodiments of the present disclosure may be directly executed and completed by a hardware processor, or executed and completed by a combination of hardware and software modules in the processor. A software module may reside in mature storage media in the field such as random access memory, flash memory, read-only memory, programmable read-only memory, electrically erasable programmable memory, or registers. The storage medium is located in a memory, and the processor reads information from the memory and performs the steps of the above method in combination with its hardware. To avoid repetition, no detailed description is provided here.

It should be noted that the processor in the embodiments of the present disclosure may be an integrated circuit chip with signal processing capability. During implementation, the steps of the method embodiments described above may be accomplished through integrated logic circuits of hardware in the processor or instructions in the form of software. The processor may be a general-purpose processor, a digital signal processor (DSP), an application-specific integrated circuit (ASIC), a field-programmable gate array (FPGA), or other programmable logic device, discrete gate or transistor logic device, or discrete hardware component. The processor may implement or execute the methods, steps, and logical block diagrams disclosed in the embodiments of this application. A general-purpose processor may be a microprocessor, or the processor may be any conventional processor, or the like. The steps of the methods disclosed in the embodiments of the present disclosure may be directly embodied as being executed and completed by a hardware decoding processor, or executed and completed by a combination of hardware and software modules in the decoding processor. A software module may reside in mature storage media in the field such as random access memory, flash memory, read-only memory, programmable read-only memory, or electrically erasable programmable memory, and registers. The storage medium is located in the memory, and the processor reads information from the memory and completes the steps of the above methods in combination with its hardware.

The above provides a detailed introduction to a method for generative design of the cold-region urban pedestrian space layout based on dynamic thermal comfort prediction proposed in some embodiments of the present disclosure. Specific examples have been used herein to illustrate the principles and implementations of the present disclosure. The description of the above embodiments is intended only to aid in understanding the method and core concepts of the present disclosure. Furthermore, for those of ordinary skill in the art, various modifications may be made to the specific implementation approaches and scope of application in accordance with the ideas of the present disclosure. In summary, the content of the present disclosure should not be construed as limiting the scope of the present disclosure.

1. A method for generative design of a cold-region urban pedestrian space layout based on dynamic thermal comfort prediction, comprising:
S1, constructing a wayfinding agent model in a cold-region pedestrian space, including:
S1.1: collecting trajectory data of pedestrian groups during a plurality of travel periods in a typical cold-region pedestrian space based on Internet of Things (IoT) perception;
S1.2: constructing a wayfinding grey-box model during each of the plurality of travel periods in the cold-region pedestrian space;
S1.3: extracting accurate pedestrian trajectories during the plurality of travel periods based on drone image data of the typical cold-region pedestrian space; and
S1.4: calibrating the wayfinding agent model based on IoT perception data of the typical cold-region pedestrian space;
S2, constructing a mapping between thermal environment data of the cold-region pedestrian space and dynamic thermal comfort data of pedestrians, including:
S2.1: obtaining pedestrian thermal sensation in the typical cold-region pedestrian space based on ecological momentary assessment (EMA);
S2.2: constructing a pedestrian thermal sensation model under winter and summer thermal environment conditions of the cold-region pedestrian space; and
S2.3: calibrating the pedestrian thermal sensation model under the winter and summer thermal environment conditions of the cold-region pedestrian space based on reinforcement learning;
S3, generating a cold-region pedestrian space layout design driven by dynamic thermal comfort data, including:
S3.1: obtaining a cold-region pedestrian space layout scheme driven by generative rules;
in step S3.1, obtaining and voxelizing layout model data of a cold-region block, applying a three-dimensional convolutional neural network to extract features of layout and building masses to obtain extracted features; dividing, based on scale features of the cold-region block, a predefined cold-region pedestrian space into three-dimensional units, performing constraint settings on a three-dimensional matrix based on design conditions of the cold-region pedestrian space and the extracted features so that a generated scheme meets a geometric and topological requirement, and under a constraint condition, allocating the three-dimensional units based on a multi-agent system to generate a cold-region pedestrian space layout, and obtaining a cold-region pedestrian space layout optimization prototype; and
S3.2: optimizing the cold-region pedestrian space layout design driven by the dynamic thermal comfort data, including:
S3.2.1: constructing a cold-region pedestrian space layout optimization model;
S3.2.2: obtaining the dynamic thermal comfort data of the pedestrians during travel periods under the cold-region pedestrian space layout; and
S3.2.3: optimizing the cold-region pedestrian space layout oriented by the dynamic thermal comfort data; and
S3.3: providing decision support for the cold-region pedestrian space layout design based on human-computer interaction;
in the step S3.3, after obtaining an optimal scheme of the cold-region pedestrian space layout oriented by the dynamic thermal comfort data, applying, based on dynamic thermal comfort data of the cold-region pedestrian space layout scheme and morphological evaluation data of the cold-region pedestrian space layout scheme by a designer, a random forest model to construct a cold-region pedestrian space layout decision model, and obtaining a preliminary decision scheme; applying a VR device and an environmental control device to provide users with a walking experience simulation of the cold-region pedestrian space layout scheme, obtaining evaluations of the cold-region pedestrian space layout scheme from the users, and using the evaluations as feedback for the cold-region pedestrian space layout decision model to further adjust the cold-region pedestrian space layout decision model, to provide an efficient and comprehensive decision support for the designer.

2. The method according to claim 1, wherein the step S2.1 includes:
S2.1.1: obtaining pedestrian positions in the cold-region pedestrian space;
S2.1.2: collecting real-time thermal sensation information of the pedestrians under changes in the pedestrian positions in the cold-region pedestrian space; and
S2.1.3: collecting real-time thermal environment data of the typical cold-region pedestrian space.

3. The method according to claim 2, wherein the step S2.1.2 includes:
collecting real-time skin temperature, heart rate, and electrodermal activity (EDA) data under the changes in the pedestrian positions based on wearable devices, and obtaining subjective evaluation data under the changes in the pedestrian positions; and
constructing a mapping relationship between physiological indicator data and the pedestrian thermal sensation in the cold-region pedestrian space to obtain the real-time thermal sensation information of the pedestrians under the changes in the pedestrian positions in the cold-region pedestrian space.

4. The method according to claim 1, wherein the step S3.2.2 includes:
S3.2.2.1: constructing a typical thermal environment prediction model during the plurality of travel periods in winter and summer under the cold-region pedestrian space layout;
S3.2.2.2: obtaining thermal environments along typical routes of the pedestrians during the plurality of travel periods in winter and summer in the cold-region pedestrian space; and
S3.2.2.3: obtaining the pedestrian thermal sensation during the plurality of travel periods along the typical routes under the cold-region pedestrian space layout.

5. The method according to claim 4, wherein the step S3.2.2.1 includes:
obtaining thermal environment images during the plurality of travel periods in winter and summer under the cold-region pedestrian space layout, clustering the thermal environment images during the plurality of travel periods, respectively, to obtain clustered images, and then constructing a mapping relationship between the cold-region pedestrian space layout and the clustered images for the plurality of travel periods in winter and summer.

6. An electronic device, comprising a memory and a processor, wherein the memory stores a computer program, and the processor is configured to execute the computer program to implement the method according to claim 1.

7. A non-transitory computer-readable storage medium for storing computer instructions, wherein the computer instructions, when executed by a processor, cause the processor to implement the method according to claim 1.
